(19) United States
(12) Patent Application Publication
(10) Pub. No.: US 2009/0194223 A1
(43) Pub. Date: Aug. 6, 2009

(54) LOW-TEMPERATURE SINTERING OF LANTHANUM STRONTIUM MANGANITE-BASED CONTACT PASTES FOR SOFCS

(75) Inventors: Benjamin P. McCarthy, Overland Park, KS (US); Larry R. Pederson, Kennewick, WA (US); Yeong-Shyung Chou, Richland, WA (US); Xiao-Dong Zhou, Richland, WA (US); Wayne A. Surdoval, Monroeville, PA (US); Lane C. Wilson, Germantown, MD (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 12/366,464

(22) Filed: Feb. 5, 2009

Related U.S. Application Data
(60) Provisional application No. 61/026,622, filed on Feb. 6, 2008.

(51) Int. Cl. C03B 29/00

(52) U.S. Cl. 156/89.16

(57) ABSTRACT

A method for forming electrical connections between parts of a fuel cell that includes subjecting a contact paste positioned between the parts to alternating flows of gasses having varying high and low partial pressures of oxygen. This method demonstrates the ability to form conductive interconnections that have sufficient mechanical stability because these pastes can be cured at a temperature less than the temperatures of the surrounding materials thus allowing desired portions to be cured while allowing other portions such as the glass or ceramic portions to maintain their desired mechanical and electrical properties.

### PRIORITY

This invention claims priority from a provisional patent application entitled Low-Temperature Sintering of Lanthanum Strontium Manganite-based Contact Pastes for SOFCs, Application No. 61/026,622, filed Feb. 6, 2008 the contents of which are hereby incorporated by reference.

### STATEMENT AS TO RIGHTS TO INVENTIONS MADE UNDER FEDERALLY-SPONSORED RESEARCH AND DEVELOPMENT

This invention was made with Government support under Contract DE-AC0576RLO1830 awarded by the U.S. Department of Energy. The Government has certain rights in the invention.

### BACKGROUND OF THE INVENTION

1. Field of the Invention

The invention generally relates to fuel cells and more particularly to solid oxide fuel cells and methods for achieving low resistance electrical contacts within the solid oxide fuel cells.

2. Background Information

Non-negligible losses due to contact resistance between metallic interconnect plates and ceramic electrodes have been observed in planar solid oxide fuel cells (SOFCs). These are typically believed to be the result of resistive interfacial scale formation, as well as low contact area between the pieces. While most contact resistance losses on the anode side are typically small, it is more challenging to achieve low resistance contacts on the cathode side, particularly where at least one ceramic-metal interface and possibly several ceramic-ceramic interfaces are present.

In some applications, various protective coatings have been applied on to the metallic interconnects to inhibit the growth of a resistive scale and to decrease chromium volatilization. However, because mechanical (unbonded) contacts between even quite conductive materials can be both highly resistive and non-linear, augmentation of the coated interconnect/cathode interface may be necessary in some applications. The application of a mechanical load can lower the resistance of unbonded ceramic contacts, however the variability in mechanical load in an SOFC stack with thermal cycles and over time presents challenges in using this approach to manage contact resistance. One promising approach to lower contact resistance between the ferritic steel interconnect and the cathode of an SOFC is through introduction of an electrical contact paste. A contact paste material ideally would be electrically conductive, stable to high temperature, provide a good thermal expansion match to other fuel cell components, and be sintered at temperatures compatible with the glass seal (˜900 to 1000° C.). Lanthanum strontium manganite (LSM) would meet most of these requirements with the exception of a sintering temperature in air (>1200° C.) that is higher than desired, which could cause damage to other fuel cell components. What is needed therefore is a method and device that provides the required advantages while simultaneously overcoming the problems and complications associated with the prior art methods. The present invention addresses these issues.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY

The present invention is a method for forming electrical connections between parts of a fuel cell that includes subjecting a contact paste positioned between the parts to alternating flows of gasses having varying high and low partial pressures of oxygen. The term “paste” refers to a physical mixture of an electrically conductive solid with a liquid organic binder. This method demonstrates the ability to form conductive interconnections that have sufficient mechanical stability because these pastes can be cured at a temperature less than the temperatures of the surrounding materials, thus allowing desired portions to be densified while preventing other portions such as the glass or ceramic portions to maintain their desired mechanical and electrical properties.

This description addresses examples having a perovskite structure where the measure of oxygen non-stoichiometry δ is greater than zero when exposed to air or oxygen at intended processing temperatures. In one embodiment of the invention, the method includes utilizing paste having a lanthanum manganite composition with the formula La₍₁₋ₓ₎Sr₍ₓ₎MnO_{3+δ} wherein x is in the range between 0 and 0.12 and wherein [symbol] is a measure of oxygen non-stoichiometry that is sensitive to temperature and oxygen partial pressure, positioned between two pieces. In another embodiment of the invention, the contact paste is a lanthanum manganite composition having the formula La₍₁₋ₓ₎Ca₍ₓ₎MnO_{3+δ} wherein x is in the range between 0 and 0.12. While these examples are provided it is to be distinctly understood that the invention is not limited thereto but may be variously alternatively configured and embodied according to the particular needs and necessities of the user.

With these contact pastes in place, gasses containing differing oxygen partial pressures can then be alternatively dispersed over the contact paste at preselected temperatures. The perovskite lattice responds by taking up oxygen at high oxygen partial pressures and by giving up oxygen at low oxygen partial pressures. For compositions having super-stoichiometric oxygen content (δ≧0) in air or pure oxygen, which are relevant to this invention, changes in oxygen content results primarily in changes in the concentration of cation vacancies in the lattice. Cation vacancy concentrations are greater at high oxygen partial pressures and are lower at low oxygen partial pressures. Gradients in cation vacancy concentrations created by alternating exposure to gas flows having high and low oxygen partial pressures results in increased mobility and therefore increased rates of sintering. By utilizing alternating partial pressures of oxygen, the sintering of these contact pastes can be obtained at a relatively lower temperature, thus preserving the integrity of the other portions in the fuel cell stack.

In one embodiment, enhanced sintering of La_{0.9}Sr_{0.1}MnO_{3+δ} was achieved by alternating exposure of contact pastes to air and a nitrogen (10 ppm oxygen) mixture at 900° C. In one example, the high oxygen partial pressure gas had at least 210,000 ppm of oxygen, and the low oxygen partial pressure gas has no more than 10 ppm of oxygen. This method was performed at a temperature of about 900 degrees C. which is significantly lower than the typical 1200 degrees C. which is typically utilized for sintering of lanthanum manganite perovskites. While this preferred embodiment is described, it is to be distinctly understood that the invention is not limited thereto, but may be variously embodied and configured according to the needs and necessities of a particular user.

In various other embodiments of the invention, the method may be performed at a variety of temperatures utilizing a variety of types of contact pastes and compositions appropriately formulated to meet the needs and necessities of a particular user. In some embodiments this contact material should either be compliant or provide a good thermal expansion match to other fuel cell components, exhibit high electrical conductivity, provide good interfacial stability, and be of low cost, among other attributes. It is also generally preferred that the contact paste be processed at temperatures compatible with that at which glass seals are typically formed (850 to 1050° C.). However the method of the present invention can also be appropriately modified to include a variety of other types of materials and applications, thus the parameters of temperature and pressure that have been provided should be understood to be illustrative and not limiting.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

FIG. 1 shows shrinkage rates measured using dilatometry for LSM-10 bars initially 55 percent dense that were exposed to either alternating air (1 hour) and nitrogen (1 hour) or to flowing air at the indicated temperatures. Densification rates at low temperature in alternating air and nitrogen were enhanced, the result of changing oxygen non-stoichiometry and cation vacancy concentrations.

FIG. 2 shows shrinkage rates measured using dilatometry for LSM-20 bars initially 58 percent dense that were exposed to conditions identical to those of FIG. 1. Densification rates were minimally enhanced in alternating air and nitrogen fox LSM-20, which exhibits a lower extent of oxygen non-stoichiometry than LSM-10.

FIG. 3 shows (a) Tensile fracture strength for two spinel-coated Crofer 22 APU coupons bonded together with 50 micron thick LSM-10 contact paste at 900° C. in alternating air (5 minutes) and nitrogen (5 minutes); (b) same as (a) except 10 micron thick LSM contact paste; (c) same as (a) except processed in flowing air; (d) tensile strength of LSM-10 to single steel coupon.

FIG. 4 shows cross-section of two Co_{1.5}Mn_{1.5}O₄ spinel-coated Crofer 22 APU coupons bonded together with screen-printed LSM-10 contact paste and heat treated for 2 hours at 900° C. in alternating air (10 minutes) and nitrogen (10 minutes).

FIG. 5 shows polished cross-section of a Co_{1.5}Mn_{1.5}O₄spinel-coated Crofer 22 APU coupon bonded to porous LSM-20 by LSM-10 contact paste. The contact paste was thermally processed in alternating air (10 minutes) and nitrogen (10 minutes) at 900° C. for 5 hours.

FIG. 6 shows elemental maps obtained by energy dispersive spectroscopy of the dense LSM-20/porous LSM-20/LSM-10 contact material interfaces.

FIG. 7 shows elemental maps obtained by energy dispersive spectroscopy of the Crofer 22 APU-Co_{1.5}Mn_{1.5}O₄ spinel coating-LSM-0 contact material interfaces.

FIG. 8 shows electrical resistivity of spinel-coated Crofer 22 APU/LSM-10 contact paste/spinel-coated Crofer 22 APU sandwich specimen versus time, measured in air at 800° C.

FIG. 9 shows Fracture Strength Results for Spinel-Coated Crofer 22APU Coupons Bonded with LSM-10 Contact Paste at 900° C.

### DETAILED DESCRIPTION OF THE INVENTION

The following description includes one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

Various preferred embodiments of various formulations of this paste are described. These include formulations where composition has the formula La₍₁₋ₓ₎Sr₍ₓ₎MnO_{3+δ} wherein x is in the range between 0 and 0.12 and wherein δ>0 in air or oxygen; and/or the formula La₍₁₋ₓ₎Ca₍ₓ₎MnO_{3+δ} wherein x is in the range between 0 and 0.12. A short-hand notation “LSM-10” is introduced to describe the composition La_{0.90}Sr_{0.10}MnO_{3+δ} and “LCM-10” is used to describe the composition La_{0.90}Ca_{0.10}MnO_{3+δ}. Similar conventions are used to describe other levels of Sr or Ca substitution for La in the perovskite structure. In addition to these formulations, a variety of other formulations are also considered within the spirit and scope of the present invention.

In one example, coupons of a ferritic stainless steel Crofer 22 APU, were coated with a protective (MnCo)₃O₄ spinel layer via spray coating to control scale growth. LSM-10/polyvinyl butyral (PVB, 17:3 weight ratio) was also applied to the Crofer 22 APU coupons using an automated screen printer and allowed to dry at 100° C. for 30 minutes. The dried ink was nominally 20 microns in thickness. Ink of a similar thickness was reapplied to one coupon and pressed, wet, against the second dried ink-covered coupon. LSM-10/PVB inks were also applied via a syringe using a pneumatic dispenser in a single step, with the wet ink pressed between the first and second coupons.

Thermal processing of steel/contact paste/steel sandwich specimens consisted of repeated and alternating exposure to air (0.21 atm O₂, 10 minutes) and to nitrogen (˜10⁻⁵ atm O₂, 10 minutes) at 900° C. within a closed-ended tube furnace at 900° C. During processing, the coupons were subjected to a uniaxial force of 35 kPa perpendicular to the plane of the contact paste. Thermal processing times of up to 10 hours were employed. A second set of coupons was exposed to air only for similar processing times. Densification rates of pre-sintered LSM-10 and LSM-20 bars (initially ˜55 percent of theoretical density) was also assessed by dilatometry in both alternating air/nitrogen and in air as a function of temperature.

The fracture strength of Crofer 22 APU coupons (˜1 cm×1 cm) bonded with LSM-10 contact paste was evaluated in tension. The metal coupons were attached with epoxy to a self-aligning grip fixture. Measurements were performed at room temperature using a cross-head speed of 0.5 mm/min. Four to seven samples were tested for each condition.

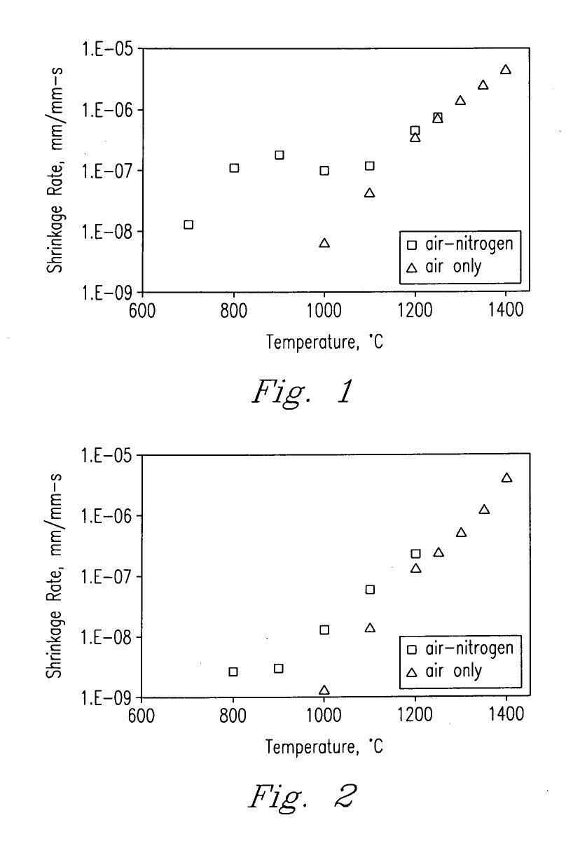

Preliminary to bonding strength studies, rates of densification of pre-sintered LSM-10 and LSM-20 bars were evaluated as a function of temperature when alternately exposed to air and to nitrogen (10⁻⁵ atm O₂). For LSM-10 pre-sintered to 55 percent of theoretical density, repeated cycling between air (1 hour) and nitrogen (1 hour) resulted in enhanced rates of densification for temperatures less than ˜1000° C. when compared to an extrapolation of rates obtained in air only, as shown in FIG. 1. Shrinkage rates were determined from a minimum of five air/nitrogen cycles, during which the extent of shrinkage per cycle remained constant. Shrinkage rates in air at temperatures less than 1000° C. were too low to be measured reliably. For temperatures of ˜100° C. and above, rates measured in alternating air-nitrogen and in air were similar. This results in the transient co-existence of cation and oxygen vacancies above equilibrium concentrations. For LSM-20 samples pre-sintered to an initial density of 58 percent of theoretical, air-nitrogen cycles led to modest, if any, enhanced densification, as given in FIG. 2. The extent of oxygen non-stoichiometry in LSM-20 in air is diminished compared to that in LSM-10, so smaller changes in oxygen and cation vacancy concentrations are expected during air-nitrogen cycles.

It thus appears possible to sinter an LSM-10 contact paste under conditions that would not simultaneously densify an LSM-20 cathode. Further, LSM-10 and LSM-20 are chemically compatible and show very similar thermal expansion behavior (11.2 and 11.3 ppm/K, respectively). The electrical conductivity of LSM-10 is adequate for use as a contact paste, though less than that of LSM-20 (˜80 S cm⁻¹ for LSM-10 versus ˜120 S cm⁻¹ for LSM-20 in air at 800° C.). The key issue addressed here is whether this approach can be used to form sufficiently strong, low resistance bonds to the cathode and to the interconnect plate within a practical time at temperatures consistent with glass seal processing.

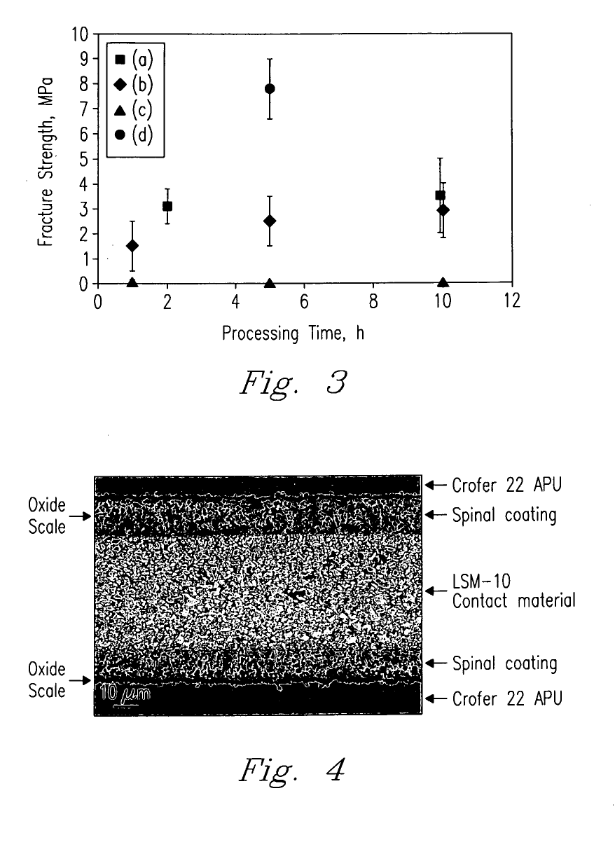

Substantial bonds between spinel-coated Crofer 22 APU ferritic steels and LSM-0 contact pastes were created by repeated cycles of alternating exposure to air and nitrogen, as shown in FIG. 3. Thermal processing was performed at 900° C., shown previously to give the greatest enhancement in sintering of LSM-10 in alternating oxygen and nitrogen exposure. A cycle time of 10 minutes (5 minutes in flowing air followed by 5 minutes in flowing nitrogen) was used, also consistent with conditions that resulted in the highest sintering rates. Bond strengths did not change significantly for processing times greater than 2 hours. Alternating air-nitrogen cycles resulted in the formation of strong bonds with LSM-10: samples processed in air alone at 900° C. developed negligible bond strengths. A cross-section of a typical coated interconnect-LSM-10 contact material-interconnect sandwich specimen processed for 2 hours at 900° C. in alternating air an nitrogen is given in FIG. 4, which shows extensive sintering within the paste itself and a continuous bond to the spinel coating. The relative density of the contact paste in FIG. 4 was estimated by image analysis to be 65±3 percent, whereas the green density was 41±3 percent. Specimens processed in air only for similar times at that temperature were quite fragile, and typically fractured while handling.

Fracture in specimens processed in alternating air and nitrogen occurred inter-granularly within the porous LSM-10 contact material, rather than at the contact paste/coated interconnect interface. Thus, bond strengths given in FIG. 3 really reflect the mechanical properties of the porous contact material and not the interfacial bond. Incomplete paste coverage for some of the samples also effectively lowered measured bond strengths and increased experimental scatter. Apparent bond strengths are substantially smaller than have been reported for fully dense LSM compositions. For LSM-12.5, a room temperature three-point bend strength of 164 MPa was reported, for which failure occurred trans-granularly. A biaxial flexure strength of ˜50 MPa was determined for LSM-20 at ambient temperature, with similar results obtained for La_{0.5}Sr_{0.5}Mn_{0.96}Cu_{0.04}O_{3±δ}. For a porosity volume fraction of 0.35, consistent with the contact paste microstructure of FIG. 4, the strength is estimated to be 9 to 25 percent of values determined for fully dense samples. Because strength is largely controlled by flaw size, which can vary widely with processing conditions for a given composition, strength values reported here are not directly comparable to literature results. However, the observation that fracture strengths for bonded metal coupons are smaller than estimated from Equation 1 and literature results for fully dense materials suggests that improvements in bond strengths are possible.

In an alternate approach to evaluate the interfacial bond strength, a single, spinel-coated steel coupon was coated with LSM-10 paste and processed in alternating air/nitrogen as previously described. In this case, the aluminum test fixture on one side was bonded directly to the sintered LSM-10 paste with epoxy. The fracture strength that was obtained was nearly 8 MPa, more than double that for metal/contact paste/metal sandwich specimens, the results of which are included in FIG. 3. Further, fracture occurred at the LSM-10/epoxy interface, so the actual LSM-10/spinel-coated Crofer 22 APU bond strength may well be even higher.

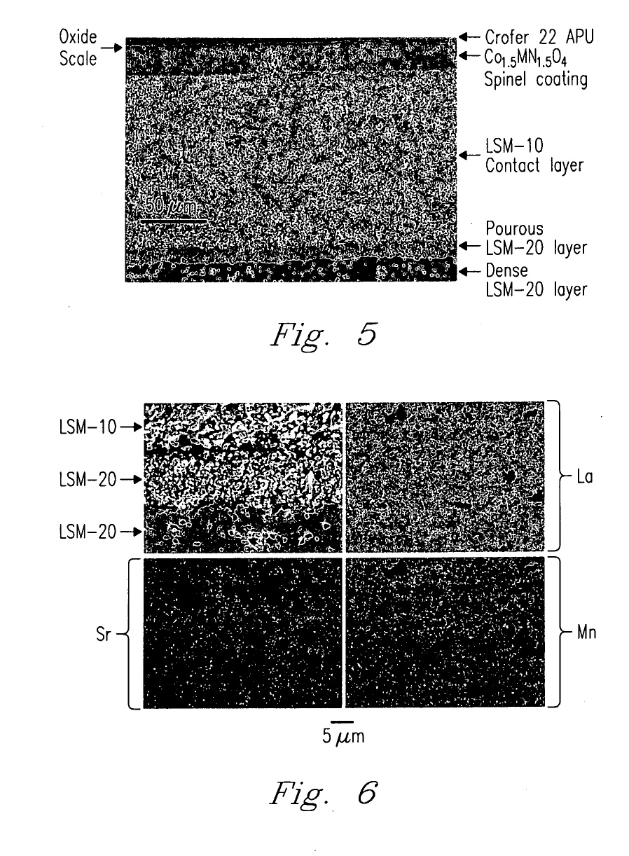

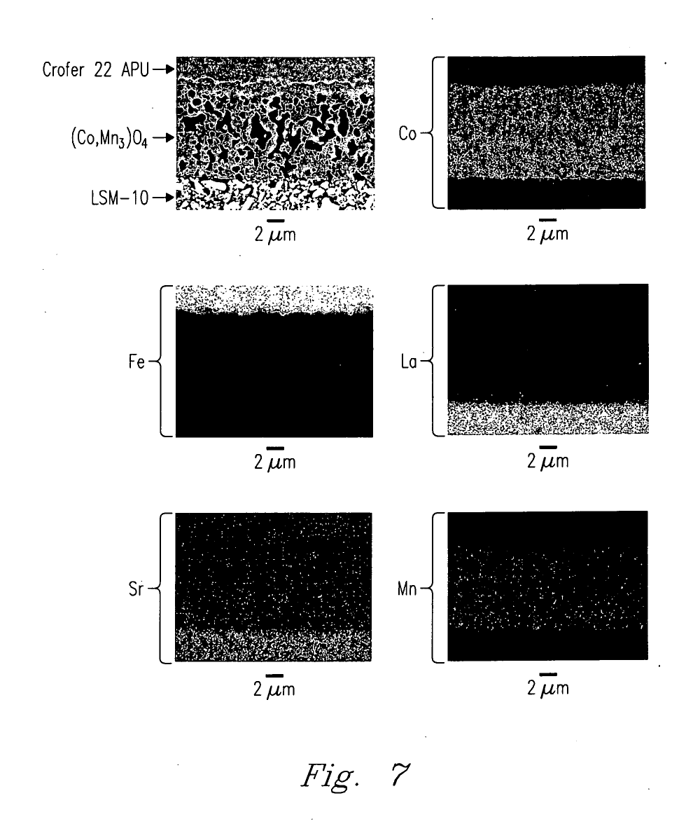

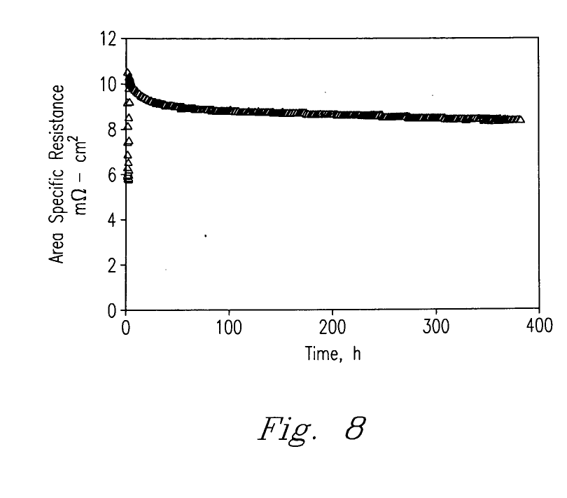

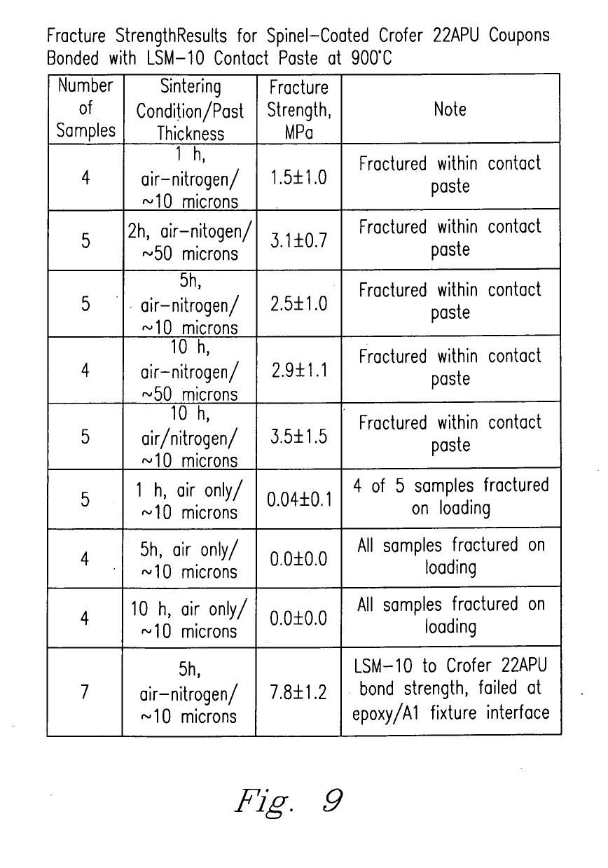

An LSM-10 contact paste was used to bond a spinel-coated Crofer 22 APU coupon to a porous LSM-20 film, which had been screen-printed onto a dense LSM-20 disk. This test fixture approximates the configuration that may be employed in a planar SOFC stack. A cross-section of a sample that had been subjected to alternating air (5 minutes) and nitrogen (5 minutes) for 2 hours at 900° C. is shown in FIG. 5. A sharp, well-bonded interface formed between the LSM-10 contact paste and porous LSM-20, with no obvious physical imperfections. The LSM-20 film retained its smaller particle size and porosity (˜60 percent relative density), while the LSM-10 contact paste sintered to approximately 65 percent relative density, as estimated using image analysis. Elemental maps of the LSM-10/LSM-20 interface given in FIG. 6 show an abrupt change in the strontium concentration, while lanthanum and manganese concentrations are relatively uniform, as expected. Similarly, the LSM-10 interface with (Co,Mn)₃O₄ spinel revealed a well-bonded interface absent of obvious imperfections. Elemental maps of this interface, which are given in FIG. 7, show sharp compositional boundaries with no indication of extensive interdiffusion or the formation of new interfacial phases. It is expected that LSM-10 contact paste would contribute minimally to the overall resistance of cells and stacks.

Assuming a bulk resistivity for LSM-10 of 0.0125 Ωcm, a porosity fraction of 0.35, and a contact paste thickness of 50 microns, a negligible additional resistance of 0.25 mΩ cm² is estimated using the following equation

$${ρ}_{porous} = {ρ}_{bulk} / ( 1 - \frac{3}{2} P ) ,$$

where ρₚₒᵣₒᵤₛ, ρ_{bulk} are resistivities of porous and bulk materials. The electrical resistivity of an interconnect/paste/interconnect sandwich specimen configured as shown in FIG. 4 was evaluated as a function of time at 800° C., as is given in FIG. 8. The resistivity was initially ˜10 mΩ cm², and improved throughout the test. As concluded previously, electrical properties of such specimens tend to be dominated by the development of an oxide scale on the ferritic steel, so contributions due to the contact paste are difficult to assess directly. The magnitude and stability of the electrical resistivity shows that this approach offers a promising new method for processing contact pastes for SOFCs.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1. A method for forming between parts of a fuel cell characterized by subjecting a contact paste positioned between said parts to alternating flows of gasses having high and low partial pressures of oxygen at a temperature less than about 1200 degrees C.

2. The method of claim 1 wherein said contact paste has a perovskite structure where the measure of oxygen non-stoichiometry δ is greater than zero when exposed to air or oxygen at intended processing temperatures.

3. The method of claim 1 wherein said contact paste is a lanthanum manganite composition having the formula La₍₁₋ₓ₎Sr₍ₓ₎MnO₃ wherein x is in the range between 0 and 0.12.

4. The method of claim 1 wherein said contact paste is a lanthanum manganite composition having the formula La₍₁₋ₓ₎Ca₍ₓ₎MnO₃ wherein x is in the range between 0 and 0.12.

5. The method of claim 1 wherein one of said gasses has less than (˜10 ppm O₂).

6. The method of claim 1 wherein the gasses are air and substantially pure oxygen.

7. The method of claim 1 wherein said high oxygen partial pressure gas has at least 100,000 ppm of oxygen.

8. The method of claim 1 wherein said low oxygen partial pressure gas has no more than 1000 ppm of oxygen.

9. The method of claim 1 wherein said method is performed at temperatures less than about 1000 degrees C.

10. The method of claim 7 wherein said contact paste is a lanthanum manganite composition having the formula La₍₁₋ₓ₎Sr₍ₓ₎MnO₃ wherein x is in the range between 0 and 0.12.

11. The method of claim 7 wherein said contact paste is a lanthanum manganite composition having the formula La₍₁₋ₓ₎Ca₍ₓ₎MnO₃ wherein x is in the range between 0 and 0.12.

12. The method of claim 7 wherein said gasses are air and nitrogen.

13. The method of claim 7 wherein said high oxygen partial pressure gas has at least 100,000 ppm of oxygen.

14. The method of claim 7 wherein said low oxygen partial pressure gas has no more than 1,000 ppm of oxygen.

15. The method of claim 1 wherein said method is performed at temperatures no greater than about 900 degrees C.

16. The method of claim 13 wherein said contact paste is a lanthanum manganite composition having the formula La₍₁₋ₓ₎Sr₍ₓ₎MnO₃ wherein x is in the range between 0 and 0.12.

17. The method of claim 13 wherein said contact paste is a lanthanum manganite composition having the formula La₍₁₋ₓ₎Ca₍ₓ₎MnO₃ wherein x is in the range between 0 and 0.12.

18. The method of claim 13 wherein said gasses are air and nitrogen.

19. The method of claim 13 wherein said high oxygen partial pressure gas has at least 100,000 ppm of oxygen.

20. The method of claim 13 wherein said low oxygen partial pressure gas has no more than 1,000 ppm of oxygen.
